(19) United States
(12) Patent Application Publication
(10) Pub. No.: US 2025/0046515 A1
(43) Pub. Date: Feb. 6, 2025

(54) METHOD OF FORMING BONDED, INDIVIDUALLY COATED WIRES

(71) Applicant: GM GLOBAL TECHNOLOGY OPERATIONS LLC, Detroit, MI (US)

(72) Inventors: Caroline Bolt, Royal Oak, MI (US); Elizabeth Pepper, Royal Oak, MI (US); Xiaohui Du, West Bloomfield, MI (US); Joshua M. Rosenberg, Sterling Heights, MI (US)

(21) Appl. No.: 18/365,448

(22) Filed: Aug. 4, 2023

(51) Int. Cl. H01F 41/12; H02K 15/04

(52) U.S. Cl. CPC H01F 41/122; H02K 15/0421

(57) ABSTRACT

A method for forming a multiwire structure having two conductive wires insulated from and bonded to each other by insulating material includes applying a first fluid coating material to a first conductive wire. The first conductive wire bearing the first fluid coating material is advanced through a first die forming a first electrically insulated conductive wire comprising a solid layer of a first insulating material on the first conductive wire. A second conductive wire is provided adjacent to the first electrically insulated conductive wire, and a second fluid coating material is applied to the second conductive wire. The first electrically insulated conductive wire and the adjacent second conductive wire bearing the second fluid coating material are then advanced through a second die to form a multiwire structure having two conductive wires electrically insulated from each other and bonded to each other by the first and second insulating materials.

### INTRODUCTION

The subject disclosure relates to forming wires, particularly wire suitable for use in stators for electric machines.

Wires used in electrical devices are typically insulated with an electrically insulating material. In the stators of electric machines, insulated conductive wires are frequently wound into a coil and an electromagnetic field is generated when alternating current is applied to the coil winding.

With the increasing demand for electric motors in transportation vehicles, improvements to stator designs are desired. Also, efficiency in manufacture of components used in the stators is desired.

### SUMMARY

In one exemplary embodiment, disclosed herein is a method for forming a multiwire structure having two conductive wires insulated from and bonded to each other by insulating material. The process includes applying a first fluid coating material to a first conductive wire wherein the first fluid coating material includes a precursor to or a fluid form of a first insulating material. The first conductive wire with the first fluid coating material is advanced through a first die and forms a first electrically insulated conductive wire having a solid layer of the first insulating material on the first conductive wire. A second conductive wire is provided adjacent to the first electrically insulated conductive wire, and a second fluid coating material is applied to the second conductive wire, wherein the second fluid coating material includes a precursor to or a fluid form of a second insulating material. The first electrically insulated conductive wire and the adjacent second conductive wire with the second fluid coating material are then advanced through a second die to form a multiwire structure having two conductive wires electrically insulated from each other and bonded to each other by the first and second insulating materials.

The method may further include providing a third conductive wire adjacent to the first electrically insulated conductive wire and separated from the second conductive wire by the first electrically insulate conductive wire, wherein the second fluid coating material is also applied to the third conductive wire. The advancing through the second die includes advancing the first electrically insulated conductive wire, the adjacent second conductive wire bearing the second fluid coating material and third conductive wire bearing the second fluid coating material through the second die to form a multiwire structure having three electrically conductive wires electrically insulated from each other and bonded to each other by the first and second insulating materials.

The method may further include providing an additional conductive wire adjacent to the multiwire structure and applying an additional fluid coating material to the additional conductive wire. The additional fluid coating material includes a precursor to or a fluid form of an additional insulating material, and advancing the additional conductive wire bearing the additional fluid coating material and the adjacent multiwire structure through an additional die to form a multiwire structure having the first, second and additional insulated conductive wires electrically insulated from each other and bonded to each other by the first, second, and additional insulating materials. The steps of providing additional conductive mire, applying additional fluid coating material, and advancing through an additional die may be repeated to form a multiwire structure having four or more insulated conductive wires bonded to each other by the first, second, and additional insulating materials.

Any two or all of the first, the second, and the additional fluid coating materials may be the same.

The applying of the fluid coating materials and advancing through the dies may occur in an oven. The dies may be enamel dies. The method may further include drawing the first, the second, or both conductive wires to a desired cross-sectional dimension in the oven before applying the first, the second or both fluid coating materials.

The fluid coating materials may be thermoplastics or thermosetting precursors. For example, the thermoplastic may include polyether-ether-ketone, polyaryletherketone, polyetheretherketoneketone, polyetherketoneketone, polyetherketone, polyetherketoneketoneetherketone, polyketone, thermoplastic polyimide, aromatic polyamide, aromatic polyester, polyphenylene sulfide, polysulfone, polyphenylsulfone, polyethersulfone, or a combination of two or more thereof. Particularly, the thermoplastic can be polyether-ether-ketone. As another example, the thermosetting precursors may be a precursor or precursors of polyvinyl acetal-phenolics, polyimides, polyamideimides, polyesters, THEIC modified polyesters, polyesterimides, polysulfones, polyphenylenesulfones, polysulfides, polyphenylenesulfides, polyetherimides, polyurethanes, polyamides, or nylons.

The applying of the fluid coating material may include providing the fluid coating material from an extruder.

The first and second dies can be crosshead dies.

The method may include collecting the multiwire structure on a spool.

The method may include forming the multiwire structure into a winding for a stator of an electric machine.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a simplified schematic of one example of an apparatus for performing the method as described herein;

FIG. 2 is a schematic of one example of an apparatus for performing the method as described herein;

FIG. 3 is a schematic of one example of the method described herein;

FIG. 4 is a schematic of one example of the method described herein;

FIG. 5 is a cross-sectional schematic of an example of a multiwire article as made by the method described herein; and

FIG. 6 is a cross-sectional schematic of an example of a multiwire article as made by the method described herein.

### DETAILED DESCRIPTION

The following description is merely exemplary in nature and is not intended to limit the present disclosure, its application or uses. It should be understood that throughout the drawings, corresponding reference numerals indicate like or corresponding parts and features.

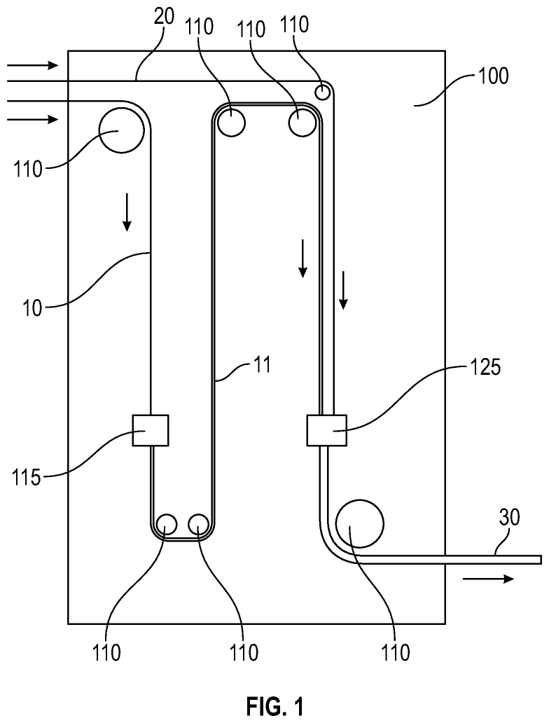

In accordance with an exemplary embodiment, the method described herein can be conducted in an oven. For example, as shown in FIG. 1, a first conductive wire 10 is fed into an oven 100, and through a die 115 (e.g., an enameling die), where a first fluid coating material is applied to the wire. After passing through the die 115, as the conductive wire 10 progresses through the oven 100 the coating material solidifies to form a first electrically insulated conductive wire 11 of the conductive wire 10 bearing a layer of first insulating material. A second conductive wire 20 is fed into the oven 100 and positioned immediately adjacent to the first electrically insulated conductive wire 11. Conductive wire 20 and the first electrically insulated conductive wire 11 both advance through a second die 125 (e.g., an enameling die), where a second fluid coating material is applied. After passing through the second die 125, the second fluid coating material solidifies to form a second insulating material. The resulting multiwire structure 30 has two electrically insulated conductive wires 10 and 20 insulated from each other by the first and/or the second insulating materials and bonded to each other by the second insulating material. The wires can be routed around pins or rollers 110.

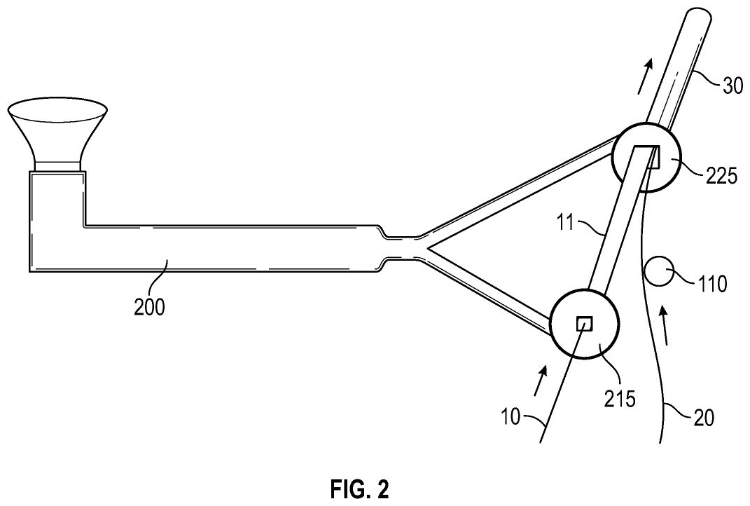

According to another exemplary embodiment, the method described herein can be conducted using an extruder. For example, as shown in FIG. 2, the first conductive wire 10 is fed through a first crosshead die 215 which provides a first fluid coating material from an extruder 200 to the wire 10. The coating material solidifies and/or cures to form the first electrically insulated conductive wire 11 of the conductive wire 10 bearing a layer of first insulating material. A second conductive wire 20 is fed adjacent to the first electrically insulated conductive wire 11 through a second crosshead die 225 where a second fluid coating material is provided from the extruder 200 and then solidified to form a second insulating material. This forms the multiwire structure 30 having two electrically insulated conductive wires 10 and 20 insulated from each other by the first and, optionally second insulating materials and bonded to each other by the second insulating material. As an alternative two separate extruders may be used, each feeding one of the crosshead dies.

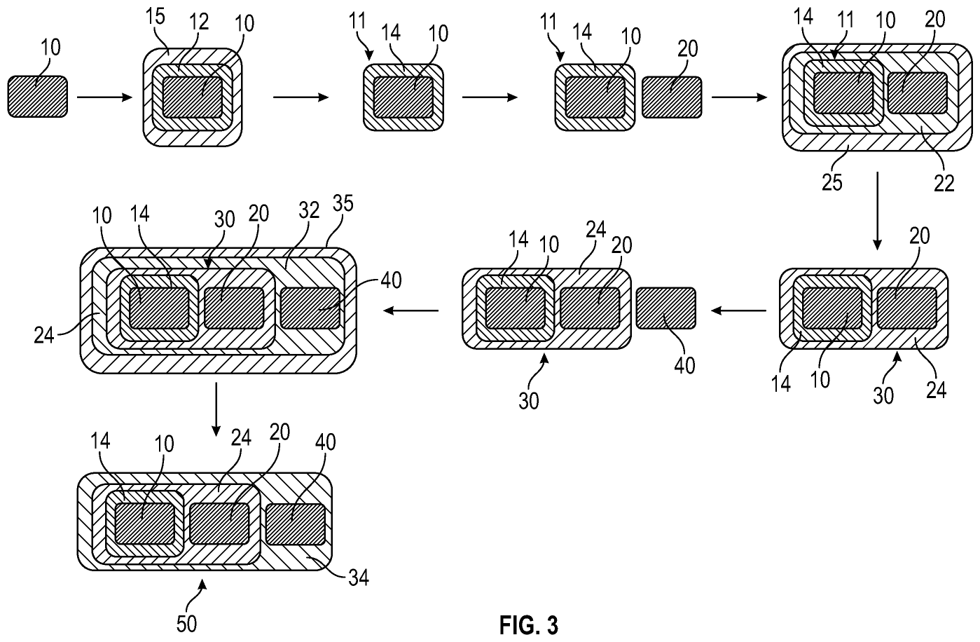

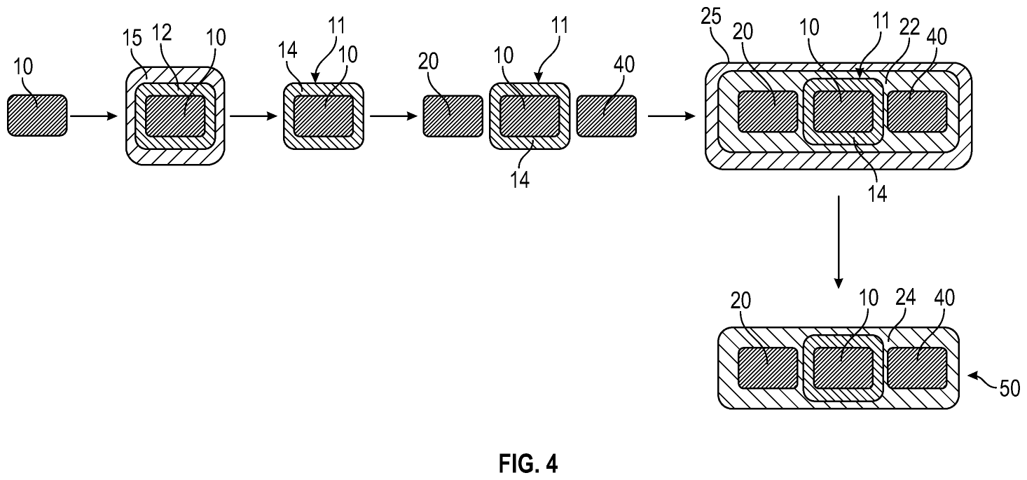

Viewed in cross-section perpendicular to the length of the wires, the method as described herein is further illustrated in examples as shown in FIGS. 3 and 4. In FIG. 3, a first conductive wire 10 is provided. In a first die 15, a first fluid coating material 12 is applied around the first conductive wire 10. The first fluid coating material 12 is solidified to form first electrically insulated conductive wire 11 having a layer of a first insulating material 14 around the first conductive wire 10. A second conductive wire 20 is then provided adjacent to the first electrically insulated conductive wire 11. In a second die 25, a second fluid coating material 22 is applied around the first electrically insulated conductive wire 11 and the second conductive wire 20. The second fluid coating material is solidified to form a multiwire structure 30 having two electrically insulated conductive wires 10 and 20 insulated from each other but bonded together by the first and second insulating materials 14 and 24. As shown, the insulating material 24 is located both surrounding conductive wire 20 and insulating material 14 and between conductive wire 20 and insulating material 14.

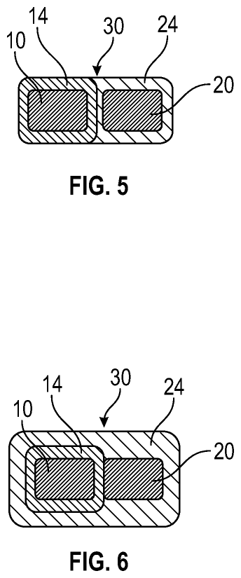

Note that the second insulating material 24 does not need to surround the first insulating material. Thus, in another embodiment, as shown in FIG. 5, bonding may be achieved if the insulating material 24 surrounds conductive wire 20 and adheres to insulating material 14 but does not surround insulating material 14. Note further that the conductive wire 20 can abut the insulating material 14. Thus, in yet another embodiment, as shown in FIG. 6, conductive wire 20 can be in direct contact with insulating material 14. Insulating material 24 can surround the other surfaces of conductive wire 20, and optionally can also surround the surfaces of the insulating material 14 which are not contacting conductive wire 20.

Optionally, as shown in FIG. 3, an additional conductive wire 40 can be provided adjacent to the multiwire structure 30. In an additional die 35, an additional fluid coating material 32 is applied around the multiwire structure 30 and the additional conductive wire 40. The additional fluid coating material is solidified to form a multiwire structure 50 having three conductive wires 10, 20 and 40 insulated from each other and bonded together with insulating materials 14, 24, and 34. The optional steps can be repeated using additional conductive wires placed adjacent to the multiwire structure and coated in additional dies.

As another example, as shown in FIG. 4, a first conductive wire 10 is provided. In a first die 15, a first fluid coating material 12 is applied around the first conductive wire 10. The first fluid coating material 12 is solidified to form first electrically insulated conductive wire 11 having a layer of a first insulating material 14 around the first conductive wire 10. A second conductive wire 20 is provided adjacent to the first electrically insulated conductive wire 11. An additional conductive wire 40 is provided adjacent to the electrically insulated conductive wire 11 and is separated from the second conductive wire by the first electrically insulated conductive wire. In a second die 25, a second fluid coating material 22 is applied around the first electrically insulated conductive wire 11, the second conductive wire 20, and the additional conductive wire 40. The second fluid coating material 22 is solidified to form a multiwire structure 50 having electrically insulated conductive wires 10, 20, and 40 insulated from each other and bonded together by the first and second insulating materials 14 and 24.

The method can include drawing the first, second, or additional conductive wire to a desired cross-sectional dimension before coating. Such drawing can occur in the oven 100 if desired.

The method can include forming additional layers of insulating material by adding additional coating dies. For example, a second layer can be added to the electrically insulated conductive wire 11 before it is bonded to the second conductive wire 20.

The method can include collecting the multiwire structure 30 or 50 on a reel or spool.

Each conductive wire 10, 20, or 40 can be any conducting wire, such as copper or aluminum. Each conductive wire 10, 20, or 40 can have the same composition or a different composition from the other conductive wires 10, 20 or 40 in the multiwire structure 30 or 50. Each conductive wire 10, 20, or 40 can have a desired cross-section, such as, for example, spherical or rectangular. Each conductive wire 10, 20, or 40 can have the same cross-section shape or a different cross-section shape from the other conductive wires 10, 20, or 40 in the multiwire structure 30 to 50. Each conductive wire 10, 20, or 40 can have a maximum cross-sectional dimension of 1 to 4 or 1.5 to 3 mm. Each conductive wire 10, 20, or 40 can have the same cross-section dimensions or a different cross-section dimension from the other conductive wires 10, 20, or 40 in the multiwire structure 30 or 50.

The first, second, and additional fluid coating materials can be the same or they can be different. The fluid coating materials can be, for example, thermoplastics or thermosets. The fluid coating materials can be, for example, enamel materials used in coating wires.

A thermoplastic fluid coating material will be in a fluid form, e.g., above a melt temperature for the material, when applied but upon cooling will solidify to form the insulating material. Examples of thermoplastics which can be used to coat and insulate the conductive wires 10, 20 or 40 include polyether-ether-ketone (“PEEK”), polyaryletherketone (“PAEK”), polyetheretherketoneketone (“PEEKK”), polyetherketoneketone (“PEKK”), polyetherketone (“PEK”), polyetherketoneketoneetherketone (“PEKKEK”), polyketone (“PK”), any other suitable material that includes at least one ketone group, thermoplastic polyimide (“PI”), aromatic polyamide, aromatic polyester, polyphenylene sulfide (“PPS”), polysulfone (“PSU”), polyphenylsulfone (“PPSU”), polyethersulfone (“PESU”), and materials that combine one or more fluoropolymers with base materials, fluoroethylene, siloxane group polymers. The thermoplastic material in fluid form can be provided, for example, from an extruder.

A thermosetting fluid coating material will be in fluid form when applied but will irreversibly cure after application (e.g., upon heating) to solidify to form the insulating material. Examples of thermosetting systems include polyvinyl acetal-phenolics, polyimides (“PI”), polyamideimides (“PAI”), polyesters, THEIC modified polyesters (e.g., tris-hydroxyl methylisocyanate modified polyesters), polyesterimides, polysulfones, polyphenylenesulfones, polysulfides, polyphenylenesulfides, polyetherimides, polyurethanes, polyamides, and nylons.

The multilayer structure made according to the above method can be formed into a winding for a stator of an electrical motor. Such motor can be used in industrial fans, blowers and pumps, machine tools, household appliances, power tools, vehicles, or disk drives. Examples of vehicles include cars, trucks, motorcycles and e-bikes. The multilayer structure may also be as electrical cable or in magnetic levitation applications.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, the test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof, without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method comprising
applying a first fluid coating material to a first conductive wire wherein the first fluid coating material comprises a precursor to or a fluid form of a first insulating material,
advancing the first conductive wire bearing the first fluid coating material through a first die and forming a first electrically insulated conductive wire comprising a solid layer of the first insulating material on the first conductive wire,
providing a second conductive wire adjacent to the first electrically insulated conductive wire,
applying a second fluid coating material to the second conductive wire, wherein the second fluid coating material comprises a precursor to or a fluid form of a second insulating material, and
advancing the first electrically insulated conductive wire and the adjacent second conductive wire bearing the second fluid coating material through a second die to form a multiwire structure having two conductive wires electrically insulated from each other and bonded to each other by the first and second insulating materials.

2. The method of claim 1 further comprising providing a third conductive wire adjacent to the first electrically insulated conductive wire and separated from the second conductive wire by the first electrically insulate conductive wire, wherein the second fluid coating material is also applied to the third conductive wire, wherein the advancing through the second die comprises advancing the first electrically insulated conductive wire, the adjacent second conductive wire bearing the second fluid coating material and third conductive wire bearing the second fluid coating material through the second die to form a multiwire structure having three electrically conductive wires electrically insulated from each other and bonded to each other by the first and second insulating materials.

3. The method of claim 1 wherein the first fluid coating material and the second fluid coating material have the same composition.

4. The method of claim 1 further comprising
providing an additional conductive wire adjacent to the multiwire structure,
applying an additional fluid coating material to the additional conductive wire, wherein the additional fluid coating material comprises a precursor to or a fluid form of an additional insulating material, and
advancing the additional conductive wire bearing the additional fluid coating material and the adjacent multiwire structure through an additional die to form a multiwire structure having the first, second and additional insulated conductive wires electrically insulated from each other and bonded to each other by the first, second, and additional insulating materials.

5. The method of claim 4 comprising repeating the steps of providing, applying, and advancing to form a multiwire structure having four or more insulated conductive wires bonded to each other by the first, second, and additional insulating materials.

6. The method of claim 4 wherein at least two of the first, second, and additional fluid coating materials are the same.

7. The method of claim 1 wherein the applying of the first and second fluid coating materials and advancing through the first and second dies occurs in an oven.

8. The method of claim 7 wherein the first die and the second die are enamel dies.

9. The method of claim 7 further comprising drawing the first, the second, or both conductive wires to a desired cross-sectional dimension in the oven before applying the first, the second or both fluid coating materials.

10. The method of claim 8 wherein the first and/or second fluid coating materials are thermoplastics comprising polyether-ether-ketone, polyaryletherketone, polyetheretherketoneketone, polyetherketoneketone, polyetherketone, polyetherketoneketoneetherketone, polyketone, thermoplastic polyimide, aromatic polyamide, aromatic polyester, polyphenylene sulfide, polysulfone, polyphenylsulfone, polyethersulfone, or a combination of two or more thereof.

11. The method of claim 1 wherein the first and second fluid coating materials are thermoplastics or thermosetting precursors.

12. The method of claim 11 wherein the first and/or second fluid coating materials are thermoplastics comprising polyether-ether-ketone, polyaryletherketone, polyetheretherketoneketone, polyetherketoneketone, polyetherketone, polyetherketoneketoneetherketone, polyketone, thermoplastic polyimide, aromatic polyamide, aromatic polyester, polyphenylene sulfide, polysulfone, polyphenylsulfone, polyethersulfone, or a combination of two or more thereof.

13. The method of claim 11 wherein the first and/or second fluid coating materials are thermosetting precursors of polyvinyl acetal-phenolics, polyimides, polyamideimides, polyesters, THEIC modified polyesters, polyesterimides, polysulfones, polyphenylenesulfones, polysulfides, polyphenylenesulfides, polyetherimides, polyurethanes, polyamides, or nylons.

14. The method of claim 11 wherein the first and second fluid coating materials comprise polyether-ether-ketone.

15. The method of claim 1 wherein the applying comprises providing the fluid coating material from an extruder.

16. The method of claim 15 wherein the first die and the second die are crosshead dies.

17. The method of claim 4 wherein the additional fluid coating material comprises polyether-ether-ketone, polyaryletherketone, polyetheretherketoneketone, polyetherketoneketone, polyetherketone, polyetherketoneketoneetherketone, polyketone, thermoplastic polyimide, aromatic polyamide, aromatic polyester, polyphenylene sulfide, polysulfone, polyphenylsulfone, polyethersulfone, or a combination of two or more thereof.

18. The method of claim 4 wherein the additional fluid coating material comprises precursors of polyvinyl acetal-phenolics, polyimides, polyamideimides, polyesters, THEIC modified polyesters, polyesterimides, polysulfones, polyphenylenesulfones, polysulfides, polyphenylenesulfides, polyetherimides, polyurethanes, polyamides, or nylons.

19. The method of claim 1 further comprising collecting the multiwire structure on a spool.

20. The method of claim 1 further comprising forming the multiwire structure into a winding for a stator of an electric machine.
